(19) United States
(12) Patent Application Publication
(10) Pub. No.: US 2015/0154872 A1
(43) Pub. Date: Jun. 4, 2015

(54) SYSTEM FOR PROCESSING MOTOR VEHICLE DATA AND METHOD FOR EVALUATING DRIVING

(71) Applicants: Frank-Rene Schäfer, Kerpen-Horrem (DE); Axel Torschmeid, Koln (DE); Matthias Koch, Montigny Le Bretonneux (FR); Tina Friedrich, Koln (DE)

(72) Inventors: Frank-Rene Schäfer, Kerpen-Horrem (DE); Axel Torschmeid, Koln (DE); Matthias Koch, Montigny Le Bretonneux (FR); Tina Friedrich, Koln (DE)

(21) Appl. No.: 14/555,132

(22) Filed: Nov. 26, 2014

(30) Foreign Application Priority Data
Nov. 29, 2013 (DE) 10 2013 224 518.1

(51) Int. Cl. G08G 1/00

(52) U.S. Cl. CPC G08G 1/22

(57) ABSTRACT

A system for processing data from motor vehicles includes a server with a databank and a master computer and a first transceiver. A plurality of motor vehicles include second transceivers and display devices. The server communicates with the motor vehicles using the first transceiver which is connected bi-directionally via a wireless connection with the second transceivers. The second transceivers of the motor vehicles transmit vehicle-specific data, parameters, and information to the first transceiver of the server which receives the data. The first transceiver of the server transmits processed data and information from the server to the second transceivers of the motor vehicles that receive this data. The vehicle-specific data can be transmitted and received in real time and displayed on the display devices in the motor vehicles in a comparative manner. The system may also be used in a method for evaluating driving.

### CROSS-REFERENCE TO RELATED APPLICATIONS

This application claims priority to German Patent Application No. 10 2013 224 518.1, filed Nov. 29, 2013 entitled “System for Processing Motor Vehicle Data and Method for Evaluating Driving,” which is herein incorporated by reference.

### BACKGROUND

In motor vehicles, drivers pay attention primarily to performance, fuel consumption, the outer appearance of the vehicle, or to the comfort of the climate in the cabin. Drivers now pay attention to the functions of additional equipment, such as those intended to recognize the environment, adapt to the driving situation, entertain, and assist with navigation. During long trips, the driver must complete monotonous tasks to drive the vehicle, and these tasks require increased attention and concentration. Boredom that a driver experiences can be counteracted by additional information systems known in the prior art, for example, the transmitting of information about regions to be traveled through, or games. This can improve the driver's ability to focus their attention on the road or to traffic.

In one example, a system is disclosed with a processing unit for a travel information system. The system makes information and entertainment available to the driver and/or the passengers with minimum operating effort. The visually or acoustically transmitted travel information is dependent on the geographic position of the vehicle and on the particular situation of the vehicle. The information can come from any category, such as nearby sights, lakes, rivers, gas stations, traffic jams, hotels, restaurants, company locations or the like. The data is made available via a radio or wireless network and a server with which the system in the vehicle communicates. Alternatively, the data is stored in a data storage device, which may be situated in the vehicle.

In another example, a driver information system for a vehicle includes a digital roadmap with information about special objects (e.g. points of interest) in the surroundings of the vehicle. The driver information system further includes a heads-up display system for showing the special objects overlaid or superimposed in the field of view of the driver where the respective special object would be seen. The information about the particular objects can also be presented acoustically. The acoustic presentation is correlated with the optical presentation to the display of the heads-up display system, that the driver can associate the acoustic or audio presentation with the associated optical display. All relevant information about a particular special object is stored, processed, and made available to the system by an information-supplying system, for example, a navigation system with a databank or a connection to the internet.

In addition, in-car media systems capable of the reproduction of media products are known from the prior art in which features of information and entertainment formats are combined. Since the operation of these systems generally requires a high degree of attention, they are not suitable for entertaining the driver.

In yet another example, a vehicle tracking system comprises a GPS navigation system, special hardware, and software. In this tracking system, a user installs a mobile unit on a vehicle that includes software and allows a processor connected to the electronics of the user's vehicle to communicate with the GPS navigation system and with a remote database. Driver-specific data for the stretch traveled by the user is determined and combined by the tracking system. The driver-specific data is transmitted to a remote database where the driver-specific data of other vehicles is also stored. The mobile unit of the vehicle collects, processes, saves, and transmits the driver-specific data. The driver-specific data is compared and stored in the remote database and can be accessed by the user via the interne.

In traditional systems, the comparison of driver-specific data is based on vehicle-specific parameters and/or parameters caused by the driver such as acceleration, speed, distance, route traveled, and braking paths. It is generally immaterial whether the parameters are compared or transmitted in real time.

In addition, it is known from the prior art to quantify the potential environmental impact of driving, for example, the fuel consumption over a certain amount of time and to display it on a display. The relative degree of environmental impact may be illustrated by the growth of green leaves on the display. However, a comparison of the environmental impact of driving with the environmental impact of other vehicles or drivers is not possible using prior art systems.

Thus, there remains a need for a system and method for promoting and increasing the attention and the concentration of the driver of a motor vehicle. The system should ideally stimulate the mind, in particular during long trips with monotonous tasks and consequently prevent the occurrence of boredom. At the same time the system should stimulate the driver to an optimal driving behavior in regard to the consumption of fuel and the environmental impact of his or her driving.

### SUMMARY

The system for processing data of motor vehicles and method for evaluating driving that is disclosed provides for such a system and method. The system comprises a server with a databank and a master computer as well as a first transceiver belonging to the server and a plurality of second transceivers integrated in the vehicles. The first transceiver of the server communicates with the second transceivers of the motor vehicles via a wireless connection. Each motor vehicle has a bidirectional connection to the server. Furthermore, the system comprises display devices integrated in the motor vehicles for displaying vehicle-specific data.

According to one aspect of the system for processing data of motor vehicles, the server is constructed in such a manner that it simultaneously receives vehicle-specific data from a plurality of motor vehicles via the first transceiver, processes the data using a databank and a master computer, and transmits the processed data with the first transceiver to the plurality of motor vehicles. In addition, the motor vehicles are designed to receive the data transmitted from the server via the first transceiver and to display it on the display device. The vehicle-specific data is designed to be able to be transmitted and received in real time and to be displayed in a comparative manner in the motor vehicles.

According to another aspect of the system for processing data of motor vehicles, the display devices integrated in the motor vehicles are designed to display the vehicle-specific data of the plurality of motor vehicles as a function of a set travel stretch or as a function of a set time period.

According to a further aspect of the system for processing data of motor vehicles, the server is designed to determine maximum values, minimum values and average values of the vehicle-specific data for all motor vehicles and to transmit them to the motor vehicles. In addition, the display device of each motor vehicle is configured to display the maximum values, minimum values, and average values as well as individual values of the vehicle-specific data of the plurality of motor vehicles in a display.

It is another aspect of the system for processing data of motor vehicles that the motor vehicles are constructed with a satellite-supported locating system belonging to a vehicle navigation system. An instantaneous and/or time-dependent geographic position of the motor vehicle can be ascertained from the satellite-supported location system. Therefore, advantageous driving routes and speeds of the motor vehicles can be determined from the data of the location system.

The system for processing data of motor vehicles is preferably constructed with a sensor for measuring the pulse of the driver. The stress and the change in stress of the driver over a certain time period can be determined via the pulse as it varies in time.

In addition, the system is advantageously constructed with distance sensors for measuring the distance of the motor vehicle to objects in the surroundings of the motor vehicle, for example, other vehicles. The measured values of the driver's pulse and of the intervals to objects in the surroundings can also be transmitted as vehicle-specific data to the server and can be processed further by the server.

It is another aspect to provide a method for evaluating the driving of a driver of a motor vehicle with the above system for processing data from motor vehicles. The method includes the step of determining vehicle-specific data from a plurality of motor vehicles. Next, transmitting the data from the motor vehicles to a server. The method proceeds with receiving the data transmitted from the motor vehicles by the server. The next steps of the method are processing the data by the server and transmitting the processed data to the plurality of motor vehicles. The method further includes the step of receiving the data processed by the server by the motor vehicles. Next, displaying the data from the plurality of motor vehicles on a display device in a comparative manner. The method concludes with the step of evaluating the driving of each motor vehicle of the plurality of motor vehicles using the vehicle-specific data.

According to a further aspect of the method for evaluating the driving of a driver of a motor vehicle, the vehicle-specific data of the plurality of motor vehicles is determined at the same time, transmitted to the server, received by the server, processed and transmitted to the plurality of motor vehicles, received by the motor vehicles, and displayed on the display device in the motor vehicle in real time. Consequently, the comparative evaluation of the driving of each motor vehicle of the plurality of motor vehicles and/or of their drivers advantageously takes place in real time.

It is another aspect of the system and method to evaluate driving based on the fuel consumption and the emission of carbon dioxide. Other vehicle-specific data may be used in evaluation of the driving may include the behavior at traffic lights, the distance from other traffic participants, or observation of posted speed limits.

According to another aspect, a driving stretch is determined. Consequently, a specific driving route is defined that is used for the comparison of the vehicle-specific data of the plurality of motor vehicles.

The driving of the drivers can be compared with each other with the aid of the contrasting of the vehicle-specific data on the given driving stretch.

The motor vehicles are advantageously associated with certain groups or divisions, more specifically, the plurality of motor vehicles are combined into groups in a user-specific manner. Possible classification criteria include but are not limited to the automobile brand, a certain model or series of the brand, and the gender or the age of the driver.

The vehicle-specific data of the plurality of motor vehicles is preferably displayed as a function of a set driving stretch or as a function of a certain time frame. In addition to or instead of the displaying of the data on the display device, the vehicle-specific data for determining the driving of the driver and the comparison with the driving of other drivers can also be presented by audio signals.

Thus several advantages of one or more aspects of the system and method disclosed include an audio-visual comparison of vehicle-specific data based on the driving in real time so that a direct reaction by the driver is possible. The method and system also increases the attention and the concentration of the driver and prevent boredom during long trips with monotonous tasks. Therefore, the safety of other traffic participants is consequently increased. In addition, the driving behavior of the driver is optimized, for example, as it relates to the fuel consumption and the impact on the environment. By displaying different vehicle-specific data of vehicles associated with a common group, the different vehicle-specific data can be compared with the data of other vehicles. Finally, the method and system enables simple operation.

### BRIEF DESCRIPTION OF DRAWINGS

Other advantages will be readily appreciated, as the same becomes better understood by reference to the following detailed description when considered in connection with the accompanying drawings wherein:

FIG. 1 is a diagram of a system for processing motor vehicle data illustrating motor vehicles of a group in wireless communication with a server;

FIG. 2 is a view of a display device of an embodiment of the system for processing motor vehicle data illustrating the display of a parameter of different motor vehicles of a group as a function of a driving stretch to be traversed;

FIG. 3 is a view of a display device of an embodiment of the system for processing motor vehicle data illustrating the display of a parameter of a motor vehicle during a predetermined time period in comparison to values of other motor vehicles in the group; and

FIG. 4 is a flow chart illustrating the steps of evaluating driving.

### DETAILED DESCRIPTION

The system and method disclosed relate to processing motor vehicle data with a server and to the use of display devices integrated in motor vehicles to show vehicle-specific data that is transmitted via wireless communication between the server and each motor vehicle.

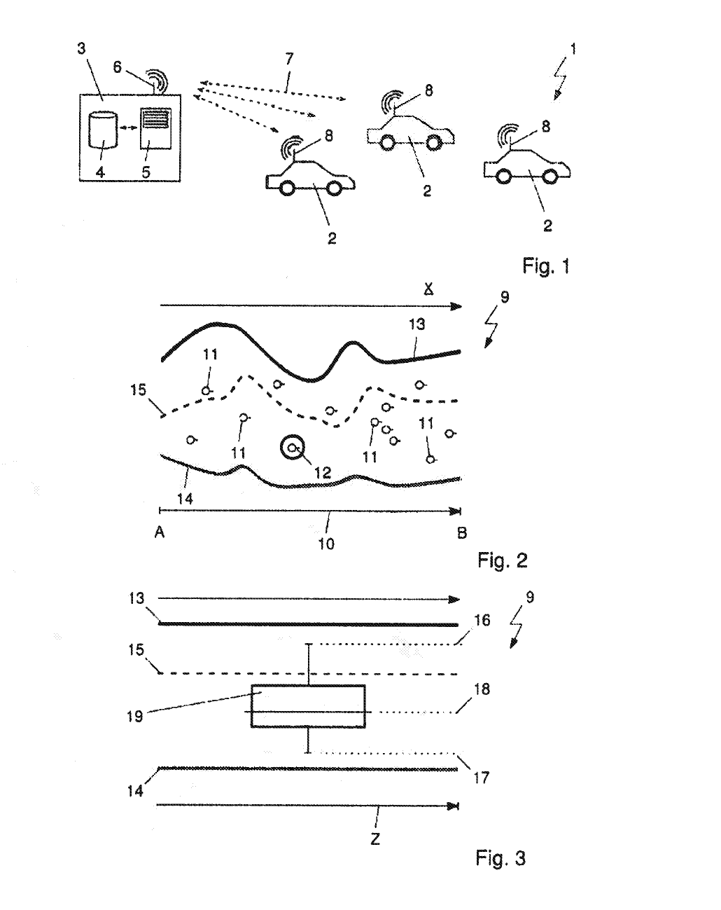

Referring to the Figures, wherein like numerals indicate corresponding parts throughout several views, FIG. 1 is a diagram of a system 1 for processing motor vehicle 2 data illustrating motor vehicles 2 of a group in wireless communication with a server 3. The motor vehicles 2 are advantageously associated with certain groups or divisions, more specifically, the plurality of motor vehicles 2 are combined into groups in a user-specific manner. Possible classification criteria include, but are not limited to the automobile brand, a certain model or series of the brand, and the gender or the age of the driver.

The motor vehicles 2 in the group are linked to each other via the system 1. Each motor vehicle 2 is driven by a driver or group participant and includes a second transceiver 8. The server 3 of the system 1 performs operations including, receiving, processing, storing, and comparing as well as transmitting relevant data and information. However, it should be appreciated that the server 3 may perform additional operations. The server 3 collects all relevant parameters such as, but not limited to fuel consumption, speed, location, a lane change, or distance from an origin A or to a destination B of the motor vehicles 2.

Vehicle-specific data includes values and qualities generated by the motor vehicles 2 that are based on the movement and the behavior of the particular motor vehicle 2. A plurality of motor vehicles 2 is defined as more than one motor vehicle 2

The server 3 consists of a databank 4 and a master computer 5 that is also designated as a host. The databank 4 and the master computer 5 are connected to one another for communicating with each other. In addition, the server 3 includes a first transceiver 6 with which it communicates via a wireless connection 7 with the second transceivers 8 of the motor vehicles 2. The second transceivers 8 of the motor vehicles 2 transmit vehicle-specific data, parameters, and information to the first transceiver 6 of the server 3 that receives the data. The first transceiver 6 of the server 3 transmits processed data and information from the master computer 5 and from the databank 4 to the second transceivers 8 of the motor vehicles 2 that receive this data. Each motor vehicle 2 is therefore bi-directionally linked to the central server 3. The drivers of each motor vehicle 2 can also make contact with each other by messages.

In an embodiment of the system 1, the server 3 is stationed at a fixed location with the databank 4 and the master computer 5. However, it should be appreciated that the server 3 may also be designed to be mobile or for the databank 4 and master computer 5 to be located in different locations.

The data (e.g. vehicle-specific data, parameters and information) is advantageously prepared to be made available and transferred via the internet. The data made available by the server 3 and the motor vehicles 2 is transmitted by a wireless network for which traditional techniques of wireless transmission can be used. The second transceivers 8 of the motor vehicles 2 are connected to the first transceivers 6 of the server 3 in order to make the data available via the internet. The second transceiver 8 disposed in the motor vehicle 2 communicates via the wireless network with the first transceiver 6 of the server 3 and transmits the relevant data.

The geographical position of the motor vehicle 2 can be ascertained from a satellite-supported locating system 1, for example, the global position determining system 1, also known as GPS, and is supplied to the server 3. The routes and speeds of the motor vehicles 2 can be determined from the data of the position determining system 1.

The motor vehicles 2 of an embodiment also include a display device 9 (FIG. 2) for displaying a parameter such as, but not limited to fuel consumption, speed, location, lane change, or distance of different vehicles of a group as a function of a driving stretch 10 to be traversed. The parameter shown as an example in FIG. 2 is the fuel consumption.

The driving stretch 10 extends from an origin A (i.e. the starting point of the motor vehicle 2) to a destination B. The display of the particular individual values 11 of a parameter of the motor vehicles 2 of the group for the driving stretch 10 is updated based on the position the motor vehicle 2 of the particular driver is in relation to the entire driving stretch 10 at a certain point in time. The individual values 11 are displayed by configurable symbols. The symbols can have different forms and shapes depending on a certain bonus system 1 or the exceeding or dropping below of threshold values. In addition, different parameters are associated with different symbols.

During a transmission of the individual values 11 in real time or close to real time, the position of the particular motor vehicle 2 is shown as compared to the other motor vehicles 2 as a function of the driving stretch 10. The particular parameters of the motor vehicles 2 are displayed during travel so that the driver can check his behavior and the performance in comparison to other drivers using the various parameters. Simultaneous or real time denotes that the vehicle-specific data accumulating for processing is constantly operationally ready so that even processed data is available within a given short time span. The system 1 ensures that no delays occur that prevent the availability of this vehicle-specific data. The processing of the data takes place within a time as required for the particular application. The entire processing of the data prior to its display takes place almost simultaneously with the corresponding processes in reality.

An emphasized value 12 of a particular parameter of the individual motor vehicle 2 is emphasized by a marked symbol in order to offer a rapid and uncomplicated view of the emphasized value 12 to the driver of the group. The attention of the driver is retained by not having to search for the emphasized value 12.

In order to achieve a better quantification of the emphasized value 12 of a parameter of the individual motor vehicle 2, the composite maximum 13, composite minimum 14, and the composite average 15 of a parameter are displayed for all motor vehicles 2 using lines. As illustrated as an example in FIG. 2, the fuel consumption of the individual motor vehicle 2 is below the composite average 15.

The display device 9 can also show the motor vehicle quantity X (i.e. number of drivers) of the group. As described above, the groups can be composed based on specific characteristics of the drivers or users and the group can refer, for example, to a certain automobile brand, a certain model or series of the brand, or to the gender of the driver.

FIG. 3 illustrates the display device 9 displaying a parameter of a motor vehicle 2 over a predetermined time period Z with a comparison to parameter values of other motor vehicles 2 of the group. By way of example, the fuel consumption parameter (shown in FIG. 2) is selected. Consequently, the total consumption during the time period Z is displayed over the predetermined time period Z.

In order to quantify the emphasized value 12 of the individual motor vehicle 2, the composite maximum 13, composite minimum 14, and the composite average 15 of the parameter, in particular of the fuel consumption, of all motor vehicles 2 are shown using lines in this view as well.

As best shown in FIG. 3, in one embodiment of the system 1, 80% of the determined values of the particular parameter for the individual motor vehicle 2 are contained inside the borders of the display element 19. Therefore, the display element 19 indicates 80% of the determined values of the fuel consumption. It should be understood that the display element 19 in other embodiments may display more or less than 80% of the determined values of the particular parameter for the individual motor vehicle 2. As illustrated as an example in FIG. 3, an individual maximum 16 of the fuel consumption of the individual motor vehicle 2 is above the composite average 15 for all drivers, while an individual average 18 of the fuel consumption of the individual motor vehicle 2 is below the composite average 15 for all motor vehicles 2. An individual minimum 17 of the fuel consumption of the individual motor vehicle 2 is only somewhat higher than the composite minimum 14 for all motor vehicles 2 of the group.

The fuel consumption can be compared and displayed as the total consumption for specific time periods Z or time sections for the total time, for example, weeks or months.

In addition to the comparison of the values of the fuel consumption and the speeds, the system 1 is also designed to determine and process the values of acceleration and the braking points during a certain driving route. These values are used to evaluate the driving of the drivers. The evaluation of the driving results in an evaluation of the environmental friendliness and therefore in the emission of carbon dioxide. Consequently, the driving is evaluated as positive when the emission of carbon dioxide is minimized.

According to other embodiments, the driving stretch 10 or driving routes can be divided into very small units. And so, for example, driving on a freeway, on entrances and exits, on the highway or in the city at traffic lights or crossings and the like can be distinguished from each other.

Distance sensors and automatic distance warning devices can be integrated into the system 1. The measured distances to other motor vehicles 2 or other traffic participants from these sensors and devices can also be transmitted to the server 3 and processed in a comparative manner.

The driving behaviour of the drivers can also be evaluated according to the criterion of utilizing a maximum permitted speed (i.e. driving as rapidly as possible within the permitted limits). This can be implemented by incorporating navigation systems into the system 1 which also include, for example, data about the maximum permitted speed on certain sections of road. The navigation systems may be integrated in the motor vehicles 2 and also allow conclusions to be drawn about whether the driver avoided taking detours and therefore caused a prolongation of the driving stretch 10.

The driving behaviour of the drivers are evaluated positively when operating their motor vehicles 2 at the maximum permitted speed and/or avoiding detours for a given driving stretch 10 and negatively if they exceed the admissible maximum speed and/or take detours for a given driving stretch 10. The positive and negative evaluations are included, for example, in a bonus system and therefore in a general allocation of points.

Another criterion that may be used for a positive evaluation is the observing of a previously determined or given arrival time as “time-to-destination” function. Every deviation changes the evaluation as a function of the level of the deviated time.

The system 1 is alternatively constructed with a sensor (not shown) for measuring the driver's pulse, with which the driver's stress can be indirectly determined. Therefore, there is the possibility of causing the driver to control their level of stress (i.e. to avoid stress).

Other sensors for measuring the behaviour of the driver serve to determine a relaxed or aggressive driving. These sensors can, for example, measure whether the driver screams, blows the horn or aggravates other traffic participants. In terms of driver evaluation, relaxed driving leads to a positive evaluation while an aggressive driving leads to a negative evaluation.

In addition to the visual display of the display device 9 shown in FIGS. 2 and 3, the individual parameters for determining the driving and the comparison with the driving of other drivers can also be outputted by acoustic signals via the audio system of the motor vehicle 2 in order to further reduce the distraction of the driver.

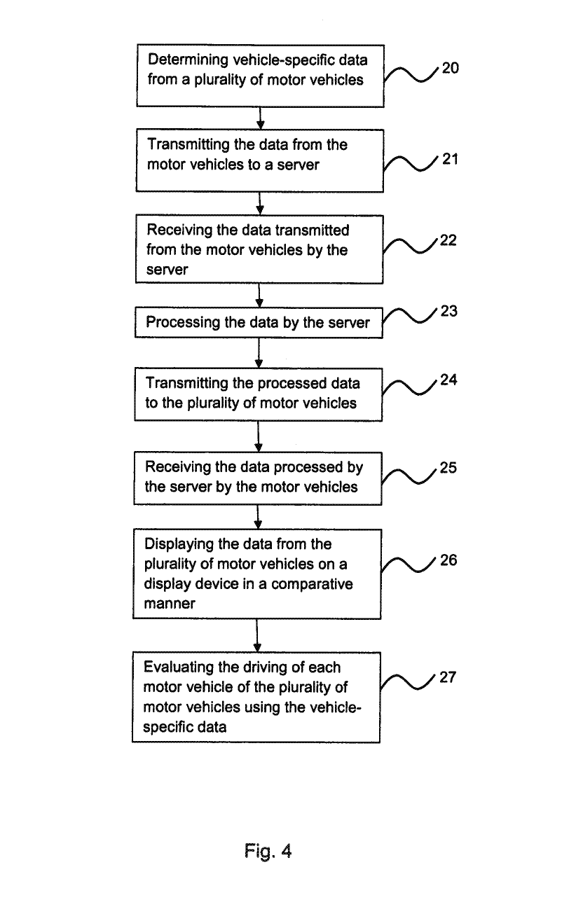

As illustrated by a flow chart in FIG. 4, a method for evaluating driving is also disclosed. The method includes the step of 20 determining vehicle-specific data from a plurality of motor vehicles 2. Next, 21 transmitting the data from the motor vehicles 2 to a server 3. The method proceeds with 22 receiving the data transmitted from the motor vehicles 2 by the server 3. The next steps of the method are 23 processing the data by the server 3 and 24 transmitting the processed data to the plurality of motor vehicles 2. The method further includes the step of 25 receiving the data processed by the server 3 by the motor vehicles 2. Next, 26 displaying the data from the plurality of motor vehicles 2 on a display device 9 in a comparative manner. The method concludes with the step of 27 evaluating the driving of each motor vehicle 2 of the plurality of motor vehicles 2 using the vehicle-specific data.

An embodiment of the method disclosed includes the steps described above. However, in this embodiment, the vehicle-specific data of the plurality of motor vehicles 2 is determined at the same time, transmitted to the server 3, received by the server 3, processed, and transmitted to the plurality of motor vehicles 2 in real time. Simultaneously, the vehicle-specific data of the plurality of motor vehicles 2 is received by the motor vehicles 2 and displayed on the display device 9 so that the comparative evaluation of the driving of each motor vehicle 2 of the plurality of motor vehicles 2 takes place in real time.

Another embodiment of the method disclosed includes the steps described above. More specifically, the evaluation of the driving is based on the fuel consumption and the emission of carbon dioxide. Other vehicle-specific data may be additionally or alternatively used in evaluation of the driving such as, but not limited to the behavior at traffic lights, the distance from other traffic participants, and observation of posted speed limits.

Obviously, many modifications and variations are possible in light of the above teachings and may be practiced otherwise than as specifically described while within the scope of the appended claims. The use of the word “said” in the apparatus claims refers to an antecedent that is a positive recitation meant to be included in the coverage of the claims whereas the word “the” precedes a word not meant to be included in the coverage of the claims.

What is claimed is:

1. A system for processing data from a plurality of motor vehicles comprising:
a server having a databank and a master computer and a first transceiver;
a plurality of second transceivers provided with each one of the motor vehicles;
the first transceiver in bidirectional communication wirelessly with the plurality of second transceivers; and
a plurality of display devices with each one of the motor vehicles, each one of the plurality of display devices configured to display vehicle-specific data,
where the server is configured to receive vehicle-specific data from the plurality of the motor vehicles, and the server is configured to process the vehicle-specific data, and transmit the processed vehicle-specific data to the plurality of the motor vehicles; and
wherein the processed vehicle-specific data for at least more than one of the plurality of motor vehicles is displayed in each of the plurality of motor vehicles.

2. The system according to claim 1, wherein each of the vehicle-specific data corresponds to a driving stretch.

3. The system according to claim 1, wherein each of the plurality of display devices displays the vehicle-specific data over a time period.

4. The system according to claim 1, wherein:
the server is configured to transmit maximum values, minimum values, and average values based on the vehicle-specific data of the plurality of motor vehicles to each of the plurality of motor vehicles, and
each of the plurality of display devices displays the maximum values, minimum values, and average values.

5. The system according to claim 1, wherein each of the plurality of motor vehicles includes a satellite-supported locating system belonging to a vehicle navigation system for ascertaining a geographic position of the motor vehicle.

6. The system according to claim 1, further comprising a sensor for measuring at least one of the plurality of vehicles driver's pulse.

7. The system according to claim 1, further comprising a plurality of distance sensors for measuring a distance of at least one of the plurality of motor vehicles in relation to objects in the surroundings of the at least of the plurality of motor vehicles.

8. A method for evaluating the driving, comprising:
determining vehicle-specific data from a plurality of motor vehicles;
transmitting the vehicle-specific data from the plurality of motor vehicles to a server;
receiving the vehicle-specific data transmitted from the motor vehicles by the server;
processing the vehicle-specific data by the server;
transmitting the processed data to the plurality of motor vehicles;
receiving the data processed by the server by the motor vehicles;
displaying the data from the plurality of motor vehicles on a display device in a comparative manner; and
evaluating the driving of each motor vehicle of the plurality of motor vehicles using the vehicle-specific data.

9. The method according to claim 8, wherein the vehicle-specific data of the plurality of motor vehicles is determined at a same time, transmitted to the server, received by the server, processed and transmitted to the plurality of motor vehicles, received by the motor vehicles and displayed on the display device so that the comparative evaluation of the driving of each motor vehicle of the plurality of motor vehicles in real time.

10. The method according to claim 8, wherein the evaluation of the driving is based on the fuel consumption and the emission of carbon dioxide.
